(19) United States
(12) Patent Application Publication
(10) Pub. No.: US 2024/0045893 A1
(43) Pub. Date: Feb. 8, 2024

(54) METHOD AND SYSTEM FOR QUERYING AND DERIVING INSIGHTS ABOUT NETWORK INFRASTRUCTURE USING NATURAL LANGUAGE QUERIES

(71) Applicant: Uptycs Inc., Waltham, MA (US)

(72) Inventors: Uma Reddy, Wellesley, MA (US); Jitendranath Yenduri, Chelmsford, MA (US); Meena Vyas, Bengaluru (IN); Anudeep Kumar, Pune (IN); Chetan Vinchhi, Bangalore (IN)

(73) Assignee: Uptycs Inc., Waltham, MA (US)

(21) Appl. No.: 18/229,817

(22) Filed: Aug. 3, 2023

Related U.S. Application Data
(60) Provisional application No. 63/395,287, filed on Aug. 4, 2022.

(51) Int. Cl. G06F 16/33

(52) U.S. Cl. CPC G06F 16/3344

(57) ABSTRACT

The invention proposes a method and system for deriving real-time insights about heterogeneous infrastructure by allowing a user to post a natural language query. A natural language processing (NLP) engine converts the natural language query into a computer identifiable query. A query engine (QE), based on the computer identifiable query, predicts diverse infrastructure-specific commands. The QE utilizes Machine Learning (ML) models to understand the intent of the natural language query and predict the diverse infrastructure-specific commands. The QE transforms and forwards the infrastructure-specific commands to corresponding components of the heterogeneous infrastructure. One or more sensors integrated with the components of the heterogeneous infrastructure receive query from the QE and respond to the queries in real-time. An interpreter module converts the responses received from the sensors into a common data format and derives insights from the converted responses and transmits them to the user device.

### CROSS-REFERENCE TO THE RELATED APPLICATION

This application claims priority to U.S. Provisional Application Ser. No. 63/395,287 filed on 4 Aug. 2022, titled “METHOD AND SYSTEM FOR QUERYING AND DERIVING INSIGHTS ABOUT NETWORK INFRASTRUCTURE USING NATURAL LANGUAGE QUERIES”, the entire disclosure of which is hereby incorporated herein by reference.

### FIELD OF THE INVENTION

Various embodiments of the present invention generally relate to deriving insights about heterogeneous infrastructure. More particularly, the invention relates to a method and system for querying and deriving real-time insights about heterogenous Infrastructure using natural language queries.

### BACKGROUND OF THE INVENTION

As work across different industries is becoming increasingly data-driven, the ability to retrieve and assess data has become more critical. Existing information retrieval solutions used by enterprises and companies manage their network infrastructure. To retrieve actionable insights or anomalies about such infrastructure, significant domain expertise and mastery of database schemas, knowledge of multiple system commands, knowledge on APIs, and query languages are required. As the infrastructure becomes more complex and diverse, the above expertise is restricted to fewer and fewer people. This creates unnecessary bottlenecks in information retrieval and decision-making.

Existing art necessitates the use of sophisticated tooling and information retrieval systems that are cumbersome and hard to master and maintain.

Also, the existing information retrieval solutions do not provide the ease of using free-form or natural language to query across an enterprise's entire infrastructure (network Infrastructure) and correlate with external cyber threat intelligence.

In addition, the existing information retrieval solutions pose challenges in which users have to deal with variations in methods that are required to gather information across different kinds of infrastructure and thereby manually correlate the collected information with external sources of information such as threat intelligence, vulnerability indicators, compliance standards, etc.

Yet, the existing natural language processing models fail to consider the underlying intent of the query while providing responses to the users. This can be a significant problem in heterogeneous computing environments where understanding the intent of the query plays a key role in finding appropriate responses to the users. Another problem is the incapability of the systems to derive corresponding insights due to failure to understand the intent of the query. As used herein, intent is computer-readable data representing what a computer system component has identified as a meaning that a natural language query intended.

Therefore, given the aforementioned drawbacks, a pressing need exists for managing infrastructure by deriving real-time insights and information about the heterogeneous infrastructure using free-form or natural language interactions.

### SUMMARY OF THE INVENTION

The invention discusses a method and system for deriving real-time insights about heterogeneous infrastructure by allowing a user to post a query in free-form or natural language via a user device. A natural language processing (NLP) engine converts the natural language query into a computer identifiable query. The NLP engine utilizes one or more Machine Learning (ML) models. A query engine (QE), based on the identifiable query, predicts diverse infrastructure-specific commands. The QE utilizes one or more ML models to understand the intent of the natural language query and thereafter to predict the diverse infrastructure-specific commands. Further, the QE validates its understanding of the intent with the user to verify and learn the accuracy of intent extraction. In response to the prediction, the QE transforms and forwards the infrastructure-specific commands to corresponding components of the heterogeneous infrastructure. One or more sensors integrated with the components of the heterogeneous infrastructure receive queries from the QE and respond to the queries in real time. An interpreter module (IM) converts different types of infrastructure specific responses received from the sensors in varied formats into a common data format and derives insights from the converted responses. The derived insights can be related to set aggregations across multiple similar or dissimilar systems, in addition to the user query related insights. Finally, the IM transmits the insights to the user device.

One or more shortcomings of the prior art are overcome, and additional advantages are provided through the invention. Additional features are realized through the techniques of the invention. Other embodiments and aspects of the disclosure are described in detail herein and are considered a part of the invention.

### BRIEF DESCRIPTION OF THE FIGURES

The accompanying figures, where like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 is a block diagram that illustrates an environment in which various embodiments of the invention may function.

FIG. 2 illustrates a system diagram of a query module for deriving insights about heterogeneous infrastructure using natural language queries, in accordance with an embodiment of the invention.

FIG. 3 is a flow diagram that illustrates a method for deriving insights about heterogenous infrastructure using natural language queries, in accordance with an exemplary embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and components related to a method and system for deriving insights about network heterogeneous infrastructure using natural language queries. Accordingly, the components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Systems for deriving real-time insights about heterogenous Infrastructure, methods for deriving real-time insights about heterogenous Infrastructure, and non-transitory computer readable media having stored therein machine-readable instructions to deriving real-time insights about heterogenous Infrastructure are disclosed herein. The systems, methods, and non-transitory computer readable media disclosed herein deriving real-time insights about heterogenous Infrastructure using natural language queries. A natural language processing (NLP) engine converts a natural language query received from a user to a computer identifiable query and a query engine (QE) predicts and transforms diverse infrastructure-specific commands from the computer identifiable query which are then forwarded to corresponding components of the heterogeneous infrastructure. A plurality of sensors integrated with the components of the heterogeneous infrastructure receive and respond to the query in real-time. An interpreter module, upon receiving responses from the sensors, converts the responses into a common data format and extracts insights from the converted responses to provide them to a user on a user device.

In one general aspects of this invention, a system of one or more computer executable software and data, computer machines and components thereof, networks, and/or network equipment can be configured to perform particular operations or actions individually, collectively or in a distributed manner to cause the system of components thereof to derive real-time insights from components of heterogeneous infrastructure using natural language queries.

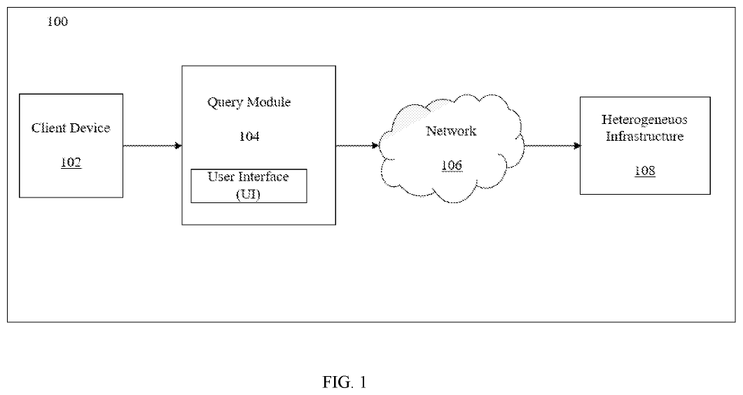

FIG. 1 is a diagram that illustrates an environment 100 in which various embodiments of the invention may function. Referring to FIG. 1, the environment 100 includes a client device 102, a query module 104, a network 106, and a network infrastructure 108.

The client device 102 is communicatively connected to the query module 104. In an embodiment, the query module 104 can be an Application Program Interface (API) that communicates, via the network 106, with the heterogeneous infrastructure 108 of an enterprise. The client device 102 may interface with the heterogeneous infrastructure 108 via a web browser, an application, or some other user interface, in addition to or in place of the query module 104.

The client device 102 can include a desktop personal computer, workstation, laptop, PDA, cell phone, or any wireless access protocol (WAP) enabled device or any other computing device capable of interfacing directly or indirectly to the Internet or other network connection allowing the users of the client device 102 to access, process and view information available to it over the network 106.

In accordance with an embodiment, the network 106 is any network or combination of networks of devices that communicate with one another. For example, the network 106 may be anyone or any combination of a local area network (LAN), wide area network (WAN), home area network (HAN), backbone networks (BBN), peer to peer networks (P2P), telephone network, wireless network, point-to-point network, star network, token ring network, single tenant or multi-tenant cloud computing networks, hub network, public switched telephone network (PSTN), or other appropriate configuration known by a person skilled in the art to interconnect the devices. The client device 102 may communicate via the network 106 using TCP/IP and use other common Internet protocols to communicate at a higher network level, such as HTTP, FTP, AFS, WAP, etc.

In accordance with an embodiment, the heterogeneous infrastructure 108 receives keywords or natural language queries from the client device 102 through the query module 104 via the network 106.

In some non-limiting embodiments, the heterogeneous infrastructure 108 comprises hardware and software, systems and devices, enabling computing and communication between users, services, applications, and processes. The heterogeneous infrastructure 108 include different types of environments such as, but not limited to, virtualized environments, bare-metal environments, a wide variety of public cloud environments, private cloud environments, hybrid cloud environments, multitudes of operating system and versions, serverless deployments via orchestration solutions, and different kind of identity providers (IDP) or authorization providers.

In other non-limiting embodiments, the heterogenous infrastructure 108 includes various types of computing systems that may range from small handheld devices, such as handheld computers or mobile telephones, as well as large mainframe systems like mainframe computers and concurrent versions systems (CVS). Other examples of information handling systems encompass pen or tablet computers, laptop or notebook computers, workstations, personal computer systems, and on-premise servers.

The heterogeneous infrastructure 108 disclosed in the present invention can include a plurality of resources. The infrastructure resources commonly found in data centers that are of different types and/or manufactured or distributed by different vendors. Non-limiting examples of types of infrastructure resources include compute infrastructure elements (e.g., processors, processor cores, computer systems, rack mount servers, and the like), storage infrastructure elements (e.g., storage systems and storage networking technologies, such as storage area networks (SAN), network attached storage (NAS), redundant array of independent disks (RAID) and the like), network infrastructure (e.g., telecommunications systems, domain name system (DNS) servers, email servers, proxy servers, network security devices (e.g., firewalls, virtual private networking (VPN) gateways, intrusion detection systems and the like), gateway systems, routers, switches, and the like) and fabric infrastructure elements (e.g., switches).

Many of the computing systems can include nonvolatile data stores, such as hard drives and/or nonvolatile memory. The embodiment of the information handling system includes separate nonvolatile data stores (more specifically, server that utilizes nonvolatile data store, mainframe computer that utilizes nonvolatile data store, and information handling system that utilizes nonvolatile data store. The nonvolatile datastore can be a component that is external to the various computing systems or can be internal to one of the computing systems. In addition, removable nonvolatile storage device can be shared among two or more computing systems using various techniques, such as connecting the removable nonvolatile storage device to a USB port or other connector of the computing systems. In some embodiments, the network of computing systems may utilize clustered computing and components acting as a single pool of seamless resources when accessed through the network 106 by one or more computing systems. For example, such embodiments can be used in a datacenter, cloud computing network, storage area network (SAN), and network-attached storage (NAS) applications.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

A cloud computing environment is service oriented with a focus on statelessness, low coupling, modularity, and semantic interoperability. At the heart of cloud computing is an infrastructure that includes a network of interconnected nodes.

In some non-limiting embodiments, the cloud computing environment includes a cloud network comprising one or more cloud computing nodes with which end user device(s) or client devices maybe used by cloud consumer to access one or more software products, services, applications, and/or workloads provided by cloud service providers or tenants of the cloud network. Examples of the user device are depicted and may include devices such as a desktop computer, laptop computer, smartphone, or cellular telephone, tablet computers and smart devices such as a smartwatch or smart glasses. Nodes may communicate with one another and may be grouped (not shown) physically or virtually, in one or more networks, such as Private, Community, Public, or Hybrid clouds as described hereinabove, or a combination thereof. This allows cloud computing environment to offer infrastructure, platforms and/or software as services for which a cloud consumer does not need to maintain resources on a local computing device.

A user interface (UI) of the query module 104 allows the users to post queries in natural language, and the search box also suggests queries to the users based on previous searches or top searches performed by the users. The UI of query module 104 facilitates the reception of user queries, encompassing various input forms, including but not limited to, keywords, phrases, sentences, large text, and voice commands. The UI of the query module 104 allows the users to query and receive insights from a diverse infrastructure that exists within an enterprise.

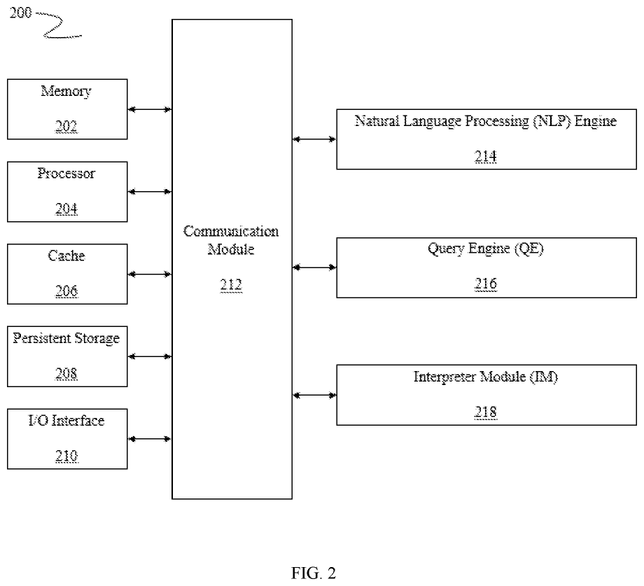

FIG. 2 illustrates a system 200 diagram of the query module 104 for deriving insights about heterogenous infrastructure 108 using natural language queries, in accordance with an embodiment of the invention. Referring to FIG. 2, the system 200 includes a memory 202, a processor 204, a cache 206, a persistent storage 208, a I/O interface 210, a communication module 212, a natural language processing (NLP) engine 214, a query engine (QE) 216, and an interpreter module (IM) 218.

The memory 202 may comprise suitable logic and/or interfaces that may be configured to store instructions (for example, the computer-readable program code) that can implement various aspects of the present invention.

The processor 204 may comprise suitable logic, interfaces, and/or code that may be configured to execute the instructions stored in the memory 202 to implement various functionalities of the query module 104 in accordance with various aspects of the present invention. The processor may be further configured to communicate with multiple modules of the search query module 104 via the communication module 212.

The cache 206 is a memory that is typically used for data or code that should be available for rapid access by the threads or cores running on the processor 204. Cache memories are usually organized into multiple levels depending upon relative proximity to the processing circuitry. Alternatively, some, or all, of the cache for the processor set may be located “off-chip”.

Computer readable program instructions are typically loaded onto the system 200 to cause a series of operational steps to be performed by the processor 204 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 206 and the other storage media discussed below. The program instructions, and associated data, are accessed by the processor 204 to control and direct the performance of the inventive methods.

The persistent storage 208, is any form of non-volatile storage for computers that is now known or to be developed in the future. The non-volatility of this storage means that the stored data is maintained regardless of whether power is being supplied to the system 200 and/or directly to the persistent storage 208. The persistent storage 208 may be a read only memory (ROM). Still, typically at least a portion of the persistent storage allows writing of data, deletion of data, and re-writing of data. Some familiar forms of persistent storage include magnetic disks and solid-state storage devices. The media used by persistent storage 208 may also be removable. For example, a removable hard drive may be used for persistent storage 208. Other examples include optical and magnetic disks, thumb drives, and smart cards inserted into a drive for transfer onto another computer-readable storage medium that is also part of persistent storage 208.

The I/O interface 210 allows input and output of data with other devices that may be connected to each computer system. For example, the I/O interface(s) 210 may provide a connection to an external device(s) such as a keyboard, a keypad, a touch screen, and/or some other suitable input device. External device(s) can also include portable computer-readable storage media, such as, for example, thumb drives, portable optical or magnetic disks, and memory cards. Program instructions and data (e.g., software and data) used to practice embodiments of the present invention can be stored on such portable computer-readable storage media and loaded onto the persistent storage 208 via the I/O interface(s) 210.

The communication module 212 comprises suitable logic, interfaces, and/or code that may be configured to transmit data between modules, engines, databases, memories, and other components of the query module 104 for use in performing functions discussed herein. The communication module 206 may include one or more communication types and utilize various communication methods for communication within the query module 104.

In accordance with an embodiment, the NLP engine 214 converts the natural language queries posted by the users post into computer identifiable queries taking into account the context associated with the user queries. The computer identifiable queries are then sent to the QE 210.

In the context of the present invention, the term “query” refers to a request for information, which may involve accessing a database environment, gathering data on running processes across multiple systems, or obtaining real-time insights into user queries. Examples of such queries include determining users who have executed root privilege commands on a production system, identifying publicly accessible S3 buckets created by users, or detecting containers launched with potentially harmful or vulnerable docker images.

Some queries addressed in this disclosure involve natural language queries, which can be in the form of textual content. A natural language query need not be a syntactically correct, complete sentence, or even formed as a question; these criteria are not mandatory requirements. It may consist of a sequence of tokens that do not conform to question syntax, lack completeness as a sentence, or violate syntax rules of the natural language.

Queries can also be represented in structured forms, such as a query data structure, or simply as a string (referred to as a “query string”) that adheres to the exposed interface of a database engine, an operating system, or a REST API.

Through Natural Language Processing (NLP) analysis, a query's primary purpose (referred to as “intent”) can be identified, along with additional information (referred to as “query parameters”) that specifies the details of the requested information.

The process of handling a query involves retrieving any necessary data, analyzing the retrieved data to determine the requested information, and providing a response containing the requested information. This whole process is collectively referred to as “fulfillment” of the query.

NLP refers to processing natural language by software on a computer in one or more phases. One phase of NLP can involve categorization of text. Categorization can use a variety of tools (with respective rules) including, without limitation: a lexical rule, which can identify known words and replace them with corresponding standard tokens; an annotator, which can recognize word patterns and assign standard tokens to one or more of the words in the pattern; a named entity recognition, which can recognize named entities and replace them with corresponding standard tokens. The categorized text can have respective semantic functions. Another phase of NLP can involve parsing, in particular, to generate a tree representing the input text. A root node of a parse tree represents the entire input text, and leaf nodes of the parse tree represent individual tokens. Bottom-up categorization of the input text can be used to identify multiple candidate parse trees. A feature function can be used to score each candidate parse tree. In some examples, features can be the number of times each available rule was used during categorization, and the feature function can evaluate a weighted sum of the features. Weights for the weighted sum can be predetermined or can be learned by machine learning on a training dataset. Yet another phase of NLP can be extraction of the semantic content from the selected parse tree, which can be accomplished by top-down evaluation of the semantic functions in the selected parse tree.

In exemplary embodiments, the term engine refers to a software application that can provide one service, or multiple related services, responsive to a succession of inputs from one or more clients. Particularly, NLP engine 214 refers to an engine that extracts structure (in particular, a query data structure) from natural language input (in particular, a natural language query).

In an exemplary embodiment, the NLP engine 214 is capable of converting natural language queries into computer-identifiable queries, system commands, and APIs leveraging one or more Machine Learning (ML) models.

In an exemplary embodiment, the intent, refers to the primary classification of a natural language input (such as a query). This classification indicates the purpose or goal of the input (query). The NLP engine 214 is capable of generating the intent as an output in response to a given natural language query. Queries sharing a common intent can be implemented differently, leading to various query destinations.

The query engine 216 receives the computer identifiable query from the NLP engine 214. The QE 216 is then configured to convert computer identifiable query into diverse infrastructure-specific commands. The QE 216 leverages one or more ML models to determine the intent of the natural language query and predict the corresponding infrastructure-specific commands.

In an embodiment, the QE 216 may be trained using large language models to comprehend the intent of a given query and contextualize that intent. This includes the ability to identify the specific system for which the query is intended, such as cloud, K8s (Kubernetes), endpoints, CVS (Concurrent Versions System), and others.

Diverse infrastructure-specific commands encompass a range of possibilities, including but not limited to Application Programming Interfaces (API) calls. These APIs may include, among others, container orchestration API, Cloud API, Identify provider (IDP) API, Infrastructure Provisioning API, and CVS API, commands for UNIX-based systems, Docker-based commands, Windows-specific commands, shell-based commands systems, SQL-based commands, and commands for other operating systems.

In some non-limiting embodiments, the infrastructure specific commands includes one of read-only commands and/or write commands.

In an exemplary embodiment, ML models disclosed in the present invention are used to characterize a tool, implemented by software in a computing environment, having a particular task for which its performance can improve from experience without being explicitly programmed with any attendant improvements in logic. Training data, often comprising inputs and corresponding correct or desired outputs, refers to a corpus of data with which an ML tool can improve its performance for the particular task, and training refers to a process for improving the performance of the ML tool. ML tools can perform tasks such as classification, regression, prediction, or factor analysis. Examples of ML tools can include, without limitation, neural networks, decision trees, random forests, and support vector machines.

In an embodiment, the QE 216 is trained using Artificial Intelligence (AI), ML models, log parsing techniques, and/or NLP algorithms to obtain human or domain intelligence which enables the QE 216 to predict diverse infrastructure-specific commands based on the computer identifiable query. Once trained, the QE 216 transmits infrastructure-specific commands to the corresponding components of the heterogeneous infrastructure 108 to obtain relevant answers.

In an exemplary embodiment, the training process of QE 216 involves the collection of a diverse corpus of questions posed through the QE 216 platform, leveraging both domain expertise and data knowledge. The domain expertise encompasses various areas, such as Operating Systems (OS), security, cloud technologies, IDP, virtualization, and docker-related concepts, among others.

The data knowledge used in the training process encompasses different aspects, including schema details (for example, tables and columns descriptions and names of tables and columns which tend to indicate what they contain), API documents, man pages, product documentation, blog posts, and relevant information from online platforms like Stack Overflow, among others.

To obtain the corpus of questions, a UI is provided to users, allowing them to submit questions for which they seek answers and what commands/queries/APIs may answer those. This real-time interaction with users helps build a diverse and relevant dataset for training.

Leveraging the domain expertise, a comprehensive list of system-specific commands is generated to effectively address and respond to the users' questions.

In accordance with the exemplary scenario, by utilizing the acquired corpus of natural language questions and the corresponding system commands, an ML model or an ensemble of ML models can be trained to generate system commands for new questions that may not be present in the corpus. Furthermore, the QE 216 may suggest similar questions back to the users. Natural questions can also be generated using the structure and metadata of the collected data, such as utilizing tabular format where table names and column names and descriptions can serve as a basis for generating the corpus of questions.

A plurality of sensors integrated with the components of the heterogeneous infrastructure 108 are configured to receive the queries from the QE 216 and responds to the queries in real-time to the IM 218. The plurality of sensors are configured to receive API calls, write-commands, and read-only commands.

In certain non-limiting embodiments, the plurality of sensors are also deployed on multiple virtual instances of the heterogeneous infrastructure 108. These virtual instances run within public cloud accounts with assigned roles and permissions that enable them to invoke APIs and execute system commands for a sensor over various communication protocols like HTTP, GRPC, web 3, and more.

In some non-limiting embodiments, the plurality of sensors themselves may possess a built-in mechanism to expand the scope of information collection, delivering the data in the final format expected by cloud services or interfaces, and allowing them to trigger actions and/or execute commands. For instance, these actions and/or write commands could be implemented for example as functions, that abstract multiple operating systems specific commands/API, to terminate processes and be callable remotely. They might also include commands to retrieve lists of processes, reporting common columns relevant across multiple operating systems, as well as commands for obtaining lists of virtual instances across different cloud environments.

In one embodiment, receiving the plurality of infrastructure-specific commands by the plurality of sensors involves loading a memory corresponding to each of the plurality of sensors with ML models. This assists the plurality of sensors in identifying appropriate responses, where a response can be either a single response or multiple responses. Furthermore, the user is granted the ability to select the best contextual response.

Subsequently, the IM 218 is configured to format the responses received from the sensors into a common data format. The IM 218 converts different types of infrastructure specific responses received from the sensors in varied formats into the common data format and derives insights from the converted responses. The insights derived from the converted responses may include aggregated data sets across multiple similar or dissimilar systems, in addition to insights relevant to user queries.

To achieve this, the IM 218 is configured by training using various techniques, such as large language models (LLM), intent extraction algorithms, and entity extraction algorithms. These techniques enhance the module's ability to accurately process and interpret the responses. Using the common data format, the interpreter module ensures that the responses are presented uniformly, irrespective of the original formats of the underlying commands. This unified data format could take the form of a tabular format, JSON format, or any other suitable format, ensuring consistency and ease of interpretation for users.

The IM 218 serves as a translation layer, providing responses in a common output format to users regarding the heterogeneous infrastructure 108 in response to various user queries. Based on the converted responses, the IM 218 derives insights about the heterogeneous infrastructure 108.

The derived insights are integrated with relevant recommendations and displayed to users on the client device 102. In certain instances, the IM 218 may utilize one or more ML models to derive these insights.

In an exemplary embodiment, the queries provided by users regarding the network infrastructure 108 are presented as illustrative examples, such as “What is the health of my infrastructure?”, “Is there a drop in the number of resources today?”, “Are my production servers compliant?”, “Will we pass the XXX audit?”, “How many software assets does my team own?”, “Where are all my assets located?”, “What percentage of assets are hosted in a specific cloud?”, “Which vulnerable server is exploitable?”, “What is the infrastructure cost, and which employee is vulnerable to cyber-attacks?” However, it should be understood that users can submit various other types of queries that are supported by the underlying infrastructure.

In one embodiment, users can utilize the UI of the query module 104 to submit their queries and obtain insights from external resources. The IM 218 processes these queries and provides users with insights obtained from the external resources in a common output format.

In accordance with the embodiment, an identity and access management framework is employed to authenticate users and control their access to external devices. This framework verifies user identities and access levels, enabling them to securely access and utilize insights from the external resources.

Consider an exemplary scenario of the invention wherein an IT administrator wants to quickly obtain information about the current CPU utilization of a specific server in their infrastructure. In accordance with various embodiments of the invention, the IT administrator inputs their query in natural language through the UI of the query module 104: “What is the current CPU utilization of server XYZ in my infrastructure of my production system deployed in region east-1 of AWS?”

The system's NLP engine 214 processes the query and extracts the intent, which is to obtain the current CPU utilization. It identifies the specific server as “server XYZ” within the infrastructure. For this query, the predicted intent could be “For Linux/mac systems, using top c command and for windows using an API exposed by operating system”.

Based on the analyzed query, the QE 216 predicts the infrastructure-specific command to be executed on the heterogeneous infrastructure 108. The QE 216 forwards the predicted command to the corresponding components of the heterogeneous infrastructure 108. The heterogeneous infrastructure 108 is equipped with a variety of sensors that are integrated with its various components. These sensors are designed to receive queries in real-time, allowing for immediate interaction and response. These queries can be related to different operating systems, such as Linux, Windows, and others, ensuring that the infrastructure is capable of handling a diverse range of requests and providing relevant information and insights for various system environments.

The sensors execute the infrastructure-specific command on server XYZ, retrieving the CPU utilization data in real-time.

The IM 218 receives the response from the sensors, which contains the CPU utilization data of server XYZ. The IM 218 acts as a translation layer, converting the response into a user-friendly format such as JSON.

The converted response is presented in the UI of the query module 104 for the IT administrator. They see the following response displayed in the UI: “The current CPU utilization of server XYZ in your infrastructure is 75%.” In an instance, the response displayed can also be related to CPU utilization of a list of servers along with CPU utilization time at different time slots t1, t2, t3 of each server.

The present invention's integration of NLP, infrastructure-specific commands, and a user-friendly interface allows the IT administrator to access actionable information about his infrastructure without the need for complex database queries or technical expertise.

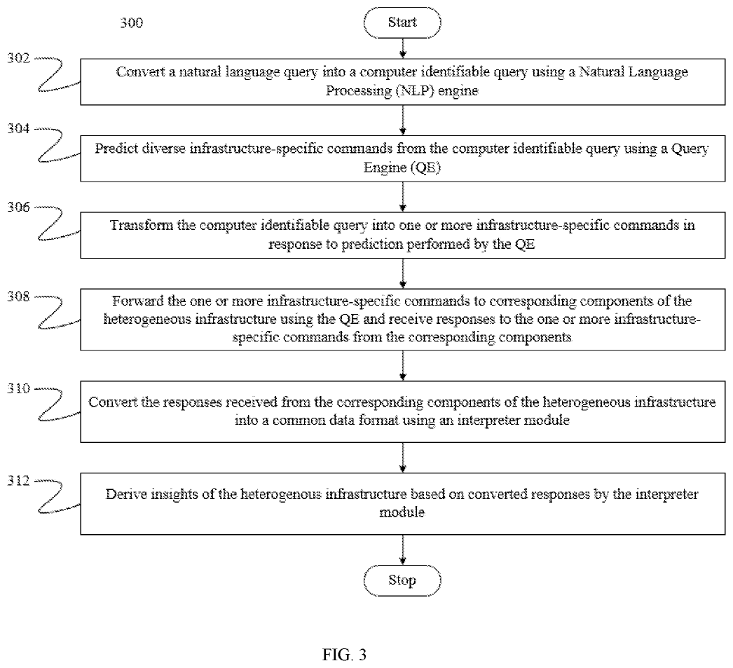

FIG. 3 is a flow diagram 300 that illustrates a method for deriving insights about the heterogeneous infrastructure 108 using natural language queries, in accordance with an exemplary embodiment of the invention.

At step 302, a natural language query received from a user is converted into a computer identifiable query by the NLP engine 214.

In an exemplary embodiment, the NLP 214 may convert the natural language queries into computer identifiable queries, system commands, and APIs.

The natural language engine 214 refers to an engine that extracts structure (in particular, a query data structure) from natural language input (in particular, a natural language query).

At step 304, the QE 216 predicts diverse infrastructure-specific commands from the computer identifiable query. The QE 216 leverages one or more Machine Learning (ML) models to determine the intent of the natural language query for predicting the diverse infrastructure specific commands.

At step 306, the QE 216 transforms the computer identifiable query into one or more infrastructure-specific commands. The diverse infrastructure-specific commands may include, but are not limited to, Application Programming Interface (API) calls. These APIs includes, but not limited to container orchestration API, Cloud API, Identify provider (IDP) API, Infrastructure Provisioning API, and CVS API, commands for UNIX-based systems, Docker-based commands, Windows-specific commands, shell-based commands systems, SQL-based commands, and commands for other operating systems.

In some non-limiting embodiments, the infrastructure specific commands can be read-only commands and/or write commands.

In In an embodiment, the QE 216 is trained using Artificial Intelligence (AI), ML models, and/or NLP algorithms to obtain human or domain intelligence which enables the QE 216 to predict diverse infrastructure-specific commands based on the computer identifiable query. Once trained, the QE 216 transmits infrastructure-specific commands to the corresponding components of the heterogeneous infrastructure 108 to obtain relevant answers.

In an exemplary embodiment, the training of QE 216 involves collecting a corpus of questions posed through QE 216, utilizing domain expertise and data knowledge. The domain expertise may pertain to various areas such as Operating Systems (OS), security, cloud, IDP, visualization, and dockers, among others. The data knowledge may encompass aspects such as schema and columns. The corpus of questions can be obtained in real-time via a UI, where users provide questions for which they seek answers. Leveraging domain expertise, a list of system-specific commands, including SQL commands, for example, can be generated to address the questions.

In accordance with the exemplary scenario, by utilizing the acquired corpus of natural language questions and the corresponding system commands, an ML model or an ensemble of ML models can be trained to generate system commands for new questions that may not be present in the corpus. Furthermore, the QE 216 may suggest similar questions back to the users. Natural questions can also be generated using the structure and metadata of the collected data, such as utilizing tabular format where table names and column names and description can serve as a basis for generating the corpus of questions.

At step 308, the QE 216 forwards the one or more infrastructure-specific commands to the corresponding components of the heterogeneous infrastructure 108 and receives responses to these commands from the respective components.

A plurality of sensors, integrated with the components of the heterogeneous infrastructure 108, are configured to receive queries from the QE 216 and provide real-time responses to the IM 218. These sensors can be configured to receive various types of queries, including API calls, write commands, and read-only commands.

In an embodiment, the reception of the plurality of infrastructure-specific commands by the plurality of sensors involves loading a memory associated with each sensor with ML models. This assists the sensors in identifying appropriate responses, wherein a response can be a single response or a multiple response. The user is allowed to determine the best contextual response.

At step 310, the IM 218 converts different types of infrastructure specific responses received from the sensors in varied formats into a unified (common) data format. The unified data format can be, for example, a tabular format, JSON format, or other suitable formats.

At step 312, the IM 218 derives insights of the heterogenous infrastructure based on the converted responses and transmits the insights to the user device. The insights derived from the converted responses may include aggregated data sets across multiple similar or dissimilar systems, in addition to insights relevant to user queries. This enables users to gain a comprehensive understanding of the collected data across their heterogeneous infrastructure.

The IM 218 serves as a translation layer, ensuring that responses about the heterogeneous infrastructure 108 are provided to users in a common output format, irrespective of the queries posted by the users. By leveraging the converted responses, the IM 218 derives insights specifically related to the heterogeneous infrastructure 108.

Consider an exemplary scenario where an IT administrator wants to obtain information about the current memory usage of a specific server and the available disk space of a storage system in their infrastructure. In accordance with various embodiments of the invention, the IT administrator inputs a query in natural language through the UI of the query module 104: “What is the current memory usage of server XYZ and the available disk space of storage system ABC in my infrastructure?”

The system's NLP engine 214 processes the query and extracts the intents, which are to obtain the current memory usage and the available disk space. It identifies the specific server as “server XYZ” and the storage system as “storage system ABC” within the infrastructure.

Based on the analyzed query, the QE engine 216 predicts the infrastructure-specific commands to be executed on the heterogeneous infrastructure 108. For the first query, the predicted command is “GET MEMORY_USAGE FROM SERVER XYZ.” For the second query, the predicted command is “GET AVAILABLE_DISK_SPACE FROM STORAGE SYSTEM ABC.”

The QE 216 forwards the predicted commands to the corresponding sensors that are designed to receive queries in real-time.

The sensors execute the infrastructure-specific commands on server XYZ and storage system ABC, retrieving the memory usage data and the available disk space.

The IM 218 receives the responses from the sensors, which contain the memory usage data of server XYZ and the available disk space of storage system ABC. The IM 218 acts as a translation layer, converting the responses into a user-friendly format.

The converted responses are presented in the UI of the query module 104 for the IT administrator. They see the following responses displayed in the UI:
“The current memory usage of server XYZ in your infrastructure is 4 GB.”
“The available disk space of storage system ABC in your infrastructure is 1 TB.”

Consider another exemplary scenario where a site engineer utilizes the query module 104 to obtain information about system vulnerabilities. The engineer inputs a natural language query through the UI of the query module 104, asking, “What entity may be affected with a particular vulnerability?”

The NLP engine 214 processes the query and extracts the intent, which is to identify entities that could potentially be impacted by a specific vulnerability.

Based on the analyzed query, the QE engine 216 predicts the infrastructure-specific commands required to be executed on the heterogeneous infrastructure 108. The predicted query could be: “Find vulnerability conditions from a central vulnerability database.”

The QE 216 forwards the predicted commands to the sensors associated with the components of the heterogeneous infrastructure 108. In response to the sensor data, the QE 216 automatically formulates one or more subsequent questions. Before executing these subsequent questions with the components, the QE 216 verifies them with the user.

Some examples of subsequent questions formulated by the QE 216 include:
“Find all systems deployed in AWS using ec2 instances types that are launched on a particular date.”
“Retrieve security group information to find what ports are exposed to the internet and accept incoming connections.”
“Is any python-based process running, which listens on a port exposed to the internet?”
“What python packages may be loaded in memory by that process?”
“What GitHub credentials are present on the system?”
“Which GitHub user do those credentials belong to?”

The sensors execute the commands and/or queries, and responses are received regarding compromised user credentials.

The IM 218 retrieves the responses from the sensors, containing data related to compromised user credentials. The IM 218 acts as a translation layer, converting these responses into a user-friendly format.

The converted responses are then presented in the UI of the query module 104 for the site engineer to view. The engineer sees the following user-friendly response displayed in the UI: “The login credentials need to be changed immediately to avoid vulnerability on system x.”

Advantageously, the present invention offers an intuitive approach to accessing insights about the network infrastructure, eliminating the need for complex database queries, domain-specific languages, or other cumbersome methods. The invention enables the instant availability of precise and actionable information desired by users. Furthermore, the invention is capable of aggregating information from diverse components of the enterprise infrastructure, regardless of the underlying infrastructure or service provided.

Moreover, the present invention provides immediate insights into enterprise infrastructure and resources, assessing their security posture in relation to industry-standard benchmarks and necessary remediation measures. The invention simplifies the evaluation of infrastructure vulnerabilities, determining their severity and offering appropriate corrective strategies. It also detects threats, providing an understanding of their scope, impact, and severity, and offers effective remediation strategies.

Those skilled in the art will realize that the above-recognized advantages and other advantages described herein are merely exemplary and are not meant to be a complete rendering of all the advantages of the various embodiments of the present invention.

As described in the invention or any of its components, the system may be embodied in the form of a computing device. The computing device can be, for example, but is not limited to, the general-purpose computer, a smartphone, a programmed microprocessor, a micro-controller, a peripheral integrated circuit element, and other devices or arrangements of devices that can implement the steps that constitute the method of the invention. The computing device includes a processor, a memory, a non-volatile data storage, a display, and a user interface.

In the foregoing complete specification, specific embodiments of the present invention have been described. However, one of ordinary skill in the art appreciates that various modifications and changes can be made without departing from the scope of the present invention. Accordingly, the specification and figures are to be regarded in an illustrative rather than a restrictive sense. All such modifications are intended to be included within the scope of the present invention.

What is claimed is:

1. A method for deriving real-time insights of heterogeneous infrastructure using natural language queries, the method comprising:
receiving a natural language query via a user device;
converting the natural language query into a computer identifiable query using a Natural Language Processing (NLP) engine;
predicting diverse infrastructure-specific commands from the computer identifiable query using a Query Engine (QE), wherein the QE leverages one or more Machine Learning (ML) models to determine an intent of the natural language query for predicting the diverse infrastructure specific commands;
transforming the computer identifiable query into one or more infrastructure-specific commands in response to prediction performed by the QE;
forwarding the one or more infrastructure-specific commands to corresponding components of the heterogeneous infrastructure using the QE and receiving responses to the one or more infrastructure-specific commands from the corresponding components, wherein the components of the heterogeneous infrastructure are integrated with one or more sensors that are configured to receive and respond to the one or more infrastructure-specific commands in real-time;
converting the responses received from the corresponding components of the heterogeneous infrastructure into a common data format using an interpreter module;
deriving, by the interpreter module, insights of the heterogenous infrastructure based on converted responses; and
transmitting, by the interpreter module, the insights to the user device.

2. The method as claimed in claim 1, wherein an infrastructure-specific command is at least one of a write-command and a read-only command.

3. The method as claimed in claim 1, wherein an infrastructure-specific command is an Application Programming Interfaces (API) call, wherein the API is at least one of container orchestration API, Cloud API, Identify provider (IDP) API, Infrastructure Provisioning API, and Concurrent Version System (CVS) API.

4. The method as claimed in claim 1, wherein the predicting comprises training the one or more ML models using training data, wherein the training data is collected from one or more data sources, the one or more data sources comprising at least one of historical natural language queries, historical commands, internet scraping, crowd sourcing, and Product Manual.

5. The method as claimed in claim 1, wherein the one or more ML models utilize at least one of natural language words, phrases, bag of words, N-gram, statements, and questions to determine intent of the natural language queries input by users.

6. The method as claimed in claim 1, wherein the one or more sensors are configured to listen to at least one of API calls, write-commands, and read-only commands.

7. The method as claimed in claim 1, wherein the receiving comprises loading a memory corresponding to each of the one or more sensors with the trained ML models to assist the one or more sensors to identify appropriate responses, wherein a response is at least one of a single response and a multiple response, wherein a user is permitted to decide a best contextual response.

8. A system for deriving real-time insights of heterogeneous infrastructure using natural language queries, the system comprising:
a memory configured to store one or more executable components; and
a processor operatively coupled to the memory, the processor configured to execute the one or more executable components, the one or more executable components comprising:
a Natural Language Processing (NLP) engine configured to convert a natural language query received from a user device into a computer identifiable query;
a Query Engine (QE) configured to predict diverse infrastructure-specific commands from the computer identifiable query, wherein the QE leverages one or more Machine Learning (ML) models to determine intent of the natural language query for predicting the diverse infrastructure-specific commands, wherein the QE is further configured to:
transform the computer identifiable query into one or more infrastructure-specific commands from the diverse infrastructure-specific commands; and
forwarding the one or more infrastructure-specific commands to corresponding components of the heterogeneous infrastructure and receiving responses to the one or more infrastructure-specific commands from the corresponding components, wherein the components of the heterogeneous infrastructure are integrated with one or more sensors that are configured to receive and respond to the one or more infrastructure-specific commands in real-time;
an interpreter module configured to:
convert the responses received from the corresponding components of the heterogeneous infrastructure into a common data format;
derive insights of the heterogenous infrastructure based on the converted responses; and
transmit the insights to the user device.

9. The system as claimed in claim 8, wherein an infrastructure-specific commands is at least one of a write-command, and a read-only command.

10. The system as claimed in claim 8, wherein an infrastructure-specific command is an Application Programming Interfaces (APIs) call, wherein the API is at least one of container orchestration API, Cloud API, Identify provider (IDP) API, Infrastructure Provisioning API, and CVS API.

11. The system as claimed in claim 8, wherein the one or more ML models are trained training data collected from one or more data sources, the one or more data sources comprising at least one of historical natural language queries, historical commands, internet scraping, crowd sourcing, and Product Manuals.

12. The system as claimed in claim 8, wherein the one or more ML models utilize at least one of natural language words, phrases, bag of words, N-gram, statements, and questions to determine intent of the natural language queries input by users.

13. The system as claimed in claim 8, wherein the sensors are configured to listen to at least one of API calls, write-commands, and read-only commands.

14. The system as claimed in claim 8, wherein a memory corresponding to each of the one or more sensors is loaded with the trained ML models to assist the one or more sensors to identify appropriate responses, wherein a response is at least one of a single response and a multiple response, wherein a user is permitted to decide a best contextual response.
